(19) United States
(12) Patent Application Publication
(10) Pub. No.: US 2022/0342484 A1
(43) Pub. Date: Oct. 27, 2022

(54) CONTROL DEVICE, CONTROL METHOD, AND PROGRAM

(71) Applicant: KABUSHIKI KAISHA TOKAI RIKA DENKI SEISAKUSHO, Aichi (JP)

(72) Inventors: Takeshi OHNISHI, Aichi (JP); Yuma NAKAI, Aichi (JP)

(73) Assignee: KABUSHIKI KAISHA TOKAI RIKA DENKI SEISAKUSHO, Aichi (JP)

(21) Appl. No.: 17/641,321

(22) PCT Filed: Apr. 17, 2020
(86) PCT No.: PCT/JP2020/016829

§ 371 Date: Mar. 8, 2022

(30) Foreign Application Priority Data
Sep. 10, 2019 (JP) 2019-164230

(51) Int. Cl. G06F 3/01

(52) U.S. Cl. CPC G06F 3/016

(57) ABSTRACT

There is provided a mechanism that can realize vibration presentation that makes a user recall a sense of metal. There is provided a control device that includes: a control section configured to vibrate a contact area when it is decided that an input section has been operated by an object, the input section having a contact area that the object contacts, and in which the control section adjusts as control parameters of control for vibrating the contact area an acceleration peak-to-peak value that is a change amount from a first extremum to a second extremum of an acceleration applied by the vibration, and an acceleration time that is a time length from a start time to an end time during which the acceleration applied by the vibration fails within a specified range.

### TECHNICAL FIELD

The present invention relates to a control device, a control method, and a program.

### BACKGROUND ART

In recent years, various devices that output feedbacks for users' operations are developed. For example, Patent Literature 1 discloses a technology that gives feedback of a user's sense of touch by vibrating a touch panel when the user pushes the touch panel.

### CITATION LIST

### Patent Literature

Patent Literature 1: JP 2010-287231A

### SUMMARY OF INVENTION

### Technical Problem

By the way, it is assumed that, when the above feedback that uses vibration is given, vibration that has little gap from an image of an operation object is presented to reduce a user's sense of strangeness. In a case where, for example, the operation object including a metal part is formed, it is desirable to present vibration that expresses a texture like metal.

Therefore, the present invention has been made in light of the above problem, and an object of the present invention is to provide a mechanism that can realize vibration presentation that makes a user recall a sense of metal.

### Solution to Problem

In order to solve the above problem, a certain aspect of the present invention provides a control device that includes: a control section configured to vibrate a contact area when it is decided that an input section has been operated by an object, the input section having a contact area that the object contacts, and in which the control section adjusts as control parameters of control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.

Furthermore, in order to solve the above problem, another aspect of the present invention provides a control method that includes: performing control for vibrating a contact area when it is decided that an input section has been operated by an object, the input section having a contact area that the object contacts, and where the performing the control further includes adjusting as control parameters of the control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.

Furthermore, in order to solve the above problem, still another aspect of the present invention provides a program that causes a computer to realize: a control function configured to vibrate a contact area when it is decided that an input section has been operated by an object, the input section having a contact area that the object contacts, and that causes the control function to adjust as control parameters of control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.

### Advantageous Effects of Invention

As described above, the present invention provides a mechanism that can realize vibration presentation that makes a user recall a sense of metal.

### BRIEF DESCRIPTION OF DRAWINGS

FIG. 1 is a view illustrating a configuration example of a system 1 according to an embodiment of the present invention.

FIG. 2 is a view for explaining control parameters according to the embodiment.

FIG. 3 is a view for explaining a control method according to the embodiment.

FIG. 4 is a view illustrating an example of a flow of a feedback process executed by the system 1 according to the embodiment.

### DESCRIPTION OF EMBODIMENTS

A preferred embodiment of the present invention will be described in detail below with reference to the appended drawings. Note that components having substantially same functional configurations will be assigned same reference numerals in the description and the drawings, and overlapping explanation thereof will be omitted.

### 1. Embodiment

### 1.1. Configuration Example

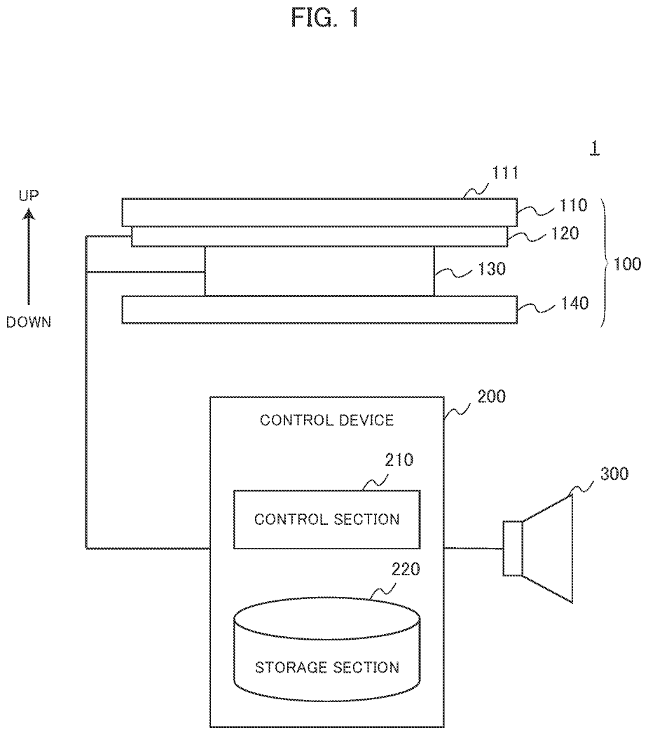

FIG. 1 is a view illustrating a configuration example of a system 1 according to the embodiment of the present invention. As illustrated in FIG. 1, the system 1 according to the present embodiment may include an input device 100, a control device 200, and a sound output device 300.

(Input Device 100)

The input device 100 according to the present embodiment detects a user's input operation on the system 1, and outputs information related to the input operation to the control device 200. Furthermore, the input device 100 according to the present embodiment performs vibration presentation that presents vibration via a sense of touch of the user who has performed the above input operation based on a control signal output by the control device 200.

As illustrated in FIG. 1, the input device 100 according to the present embodiment may include, for example, an input section 110, a detection section 120, a vibration presentation section 130, and a support part 140.

The input section 110 according to the present embodiment is a component for which the user performs an input operation, and includes a contact area 111 that an object contacts upon the input operation. In this regard, the above object may be, for example, part of a body such as a user's finger, or a pen-like tool that is gripped by the user to use. The user inputs various commands to the system 1 by performing a pushing operation and a swiping operation on the contact area 111 using the finger or the above tool. The input section 110 according to the present embodiment may be, for example, various touch panels.

The detection section 120 according to the present embodiment detects contact of the object with the contact area 111 included in the input section 110, and outputs information related to the contact of the object to the control device 200. The detection section 120 according to the present embodiment may be a pressure-sensitive sensor that converts a change of a pressure that changes in response to the user's input operation on the contact area 111 into an electric signal. Furthermore, the detection section 120 may be a capacitive sensor that converts a change of a capacitance that changes in response to the user's input operation on the contact area 111 into an electric signal.

The vibration presentation section 130 according to the present embodiment is a component that vibrates the contact area 111 of the input section 110. When, for example, the detection section 120 detects that the object has contacted the contact area 111 included in the input section 110, that is, when the detection section 120 decides that the input section 110 has been operated, the vibration presentation section 130 according to the present embodiment vibrates the input section 110 based on a control signal output by the control device 200.

In this case, the vibration presentation section 130 according to the present embodiment may be various actuators such as an Eccentric Rotating Mass (ERM) that can cause vibration, a Linear Resonant Actuator (LRA), and a piezoelectric element.

The support part 140 according to the present embodiment is a component that supports the input section 110, the detection section 120, and the vibration presentation section 130. The support part 140 according to the present embodiment is formed by a material and in a shape matching a specification of the system 1.

(Control Device 200)

The control device 200 according to the present embodiment controls operations of the input device 100 and the sound output device 300. As illustrated in FIG. 1, the control device 200 according to the present embodiment may include a control section 210 and a storage section 220.

When the detection section 120 decides that the object has contacted the contact area 111 included in the input section 110, or

when the detection section 120 decides that a specified input operation has been performed by the object based on an electric signal output by the detection section 120, the control section 210 according to the present embodiment controls the vibration presentation section 130 to vibrate the contact area 111 of the input section 110. Furthermore, the control section 210 according to the present embodiment may control the sound output device 300 to output auditory presentation that uses a sound and is presentation for a sense. A function of the control section 210 is configured by, for example, an electronic circuit such as a Central Processing Unit (CPU) or a microprocessor. Details of the function of the control section 210 according to the present embodiment will be separately described in detail.

The storage section 220 according to the present embodiment stores various pieces of information related to operations of the input device 100, the control device 200, and the sound output device 300. The storage section 220 stores, for example, information for defining a mode of vibration presentation output by the vibration presentation section 130 and a mode of auditory presentation output by the sound output device 300.

(Sound Output Device 300)

The sound output device 300 according to the present embodiment performs auditory presentation based on a control signal output by the control device 200. The sound output device 300 according to the present embodiment may be, for example, a speaker.

The configuration example of the system 1 according to the present embodiment has been described above. Note that the above configuration described with reference to FIG. 1 is a mere example, and the configuration of the system 1 according to the present embodiment is not limited to this example. For example, each function of the input device 100, the control device 200, and the sound output device 300 according to the present embodiment may be realized by a single device. The configuration of the system 1 according to the present embodiment can be flexibly altered according to a specification and an operation.

<<1.2. Details>>

Next, control of vibration presentation according to the present embodiment will be described in detail. In recent years, improvement of performance of an actuator that causes vibration makes it possible to cause various vibrations of different modes by adjusting various control parameters related to occurrence of vibration. Therefore, it is expected to, for example, significantly reduce a sense of strangeness that a user feels from presented vibration, and effectively enhance a perception degree of the vibration by presenting the vibration that matches an exterior or a specification of a system or a concept.

The present invention has been conceived by focusing on the above point, and realizes vibration presentation that makes the user recall a sense of metal. The sense of metal refers to a sense that the user feels heaviness, smallness, highness, and unity. Perceiving the sense of metal refers to feeling heaviness, smallness, highness, and unity. Perceiving no sense of metal refers to feeling lightness, largeness, lowness, and no unity. According to the present invention, in a case where, for example, the input section 110 including a metal part is formed, it is possible to significantly reduce a user's sense of strangeness and realize a more operable system by using vibration presentation that allows recalling of the sense of metal for feedback of an operation on the input section 110.

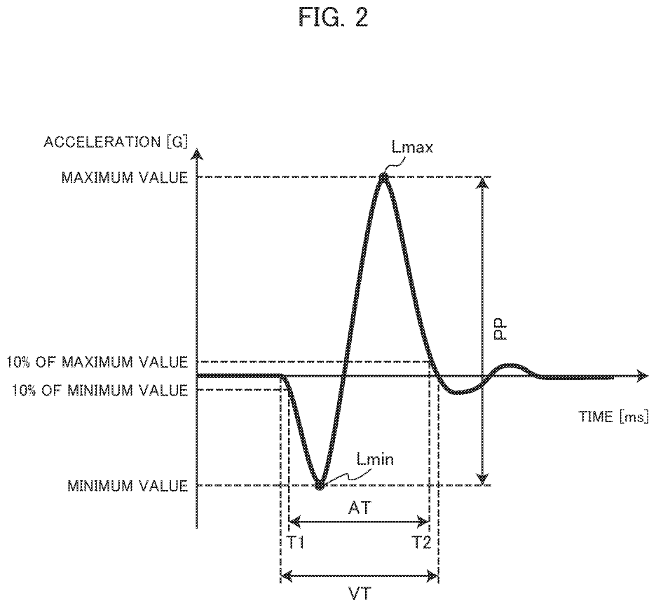

Hence, one of features of the control section 210 according to the present embodiment is that the control section 210 adjusts as control parameters of control for vibrating the contact area 111 an acceleration peak-to-peak value that is a change amount from a first extremum to a second extremum of an acceleration applied to the input section 110 (the contact area 111 of the input section 110) by the vibration, and an acceleration time that is a time length from a start time to an end time that is a specified range of the acceleration applied by the vibration. The acceleration peak-to-peak value and the acceleration time will be described in detail with reference to FIG. 2.

FIG. 2 is a view for explaining the control parameters according to the present embodiment. A vertical axis in FIG. 2 indicates an acceleration. A unit of the acceleration is G. A horizontal axis in FIG. 2 indicates a time. A unit of the time is a millisecond. FIG. 2 illustrates a time series change of the acceleration applied to the input section 110 by vibration. A vibration time VT in FIG. 2 is a time length during which the tactile presentation section 130 vibrates based on control of the control section 210. In an example, vibration of one cycle is output during the vibration time VT. An acceleration change of the vibration time VT is an acceleration change of the input section 110 due to vibration of an inertia after the vibration of the vibration presentation section 130 based on control of the control section 210 stops. In this regard, the acceleration peak-to-peak value that is the control parameter may be limited to an acceleration peak-to-peak value within a period during which the input section 110 outputs vibration based on control of the control section 210. That is, the acceleration peak-to-peak value within the time interval in which the vibration occurs due to the inertia may not be included in the acceleration peak-to-peak value that is the control parameter. In the example illustrated in FIG. 2, an acceleration peak-to-peak value PP is a change amount (difference) between a maximal value Lmax that is the first extremum of the acceleration applied to the input section 110 by vibration of one cycle during the vibration time VT, and a minimal value Lmin that is the second extremum. In this regard, the maximal value Lmax of the acceleration is a maximum value of the acceleration in a period 10, and the minimal value Lmin of the acceleration is a minimum value of the acceleration in the period 10. Hence, the acceleration peak-to-peak value PP may be regarded as a difference between the maximum value and the minimum value of the acceleration applied to the input section 110 by the vibration.

Furthermore, the acceleration time is the time length from the start time to the end time during which the acceleration applied to the input section 110 (the contact area 111 of the input section 110) by the vibration falls within the specified range. More specifically, when the acceleration applied first to the input section 110 after a start of the vibration is a positive acceleration, the start time of the acceleration time is a first time at which the acceleration takes a value of a first rate that uses the maximum value of the acceleration as a reference point. Furthermore, when the acceleration applied to the input section 110 first after the start of the vibration is a negative acceleration, the start time of the acceleration time is a first time at which the acceleration takes a value of the first rate that uses the minimum value of the acceleration as a reference point. On the other hand, when the acceleration applied to the input section 110 lastly before an end of the vibration is a positive acceleration, the end time of the acceleration time is a last time at which the acceleration takes a value of a second rate that uses the maximum value of the acceleration as a reference point. Furthermore, when the acceleration applied to the input section 110 lastly before the end of the vibration is a negative acceleration, the end time of the acceleration time is a last time at which the acceleration takes a value of the second rate that uses the minimum value of the acceleration as a reference point. In this regard, the acceleration time that is the control parameter may be limited to a time within a period during which the vibration presentation section 130 outputs vibration based on control of the control section 210. That is, the time within the time interval during which the vibration occurs due to an inertia may not be included in the acceleration time that is the control parameter. Note that the first rate and the second rate may be respectively arbitrary rates. In the example illustrated in FIG. 2, in a case of vibration of one cycle during the vibration time VT, an acceleration time AT is a time from a first time T1 at which the acceleration is 10% of the minimum value of the acceleration to a last time T1 at which the acceleration is 10% of the maximum value of the acceleration.

By adjusting the above-explained acceleration peak-to-peak value and acceleration time as the control parameters of control for vibrating the input section 110 (the contact area 111 of the input section 110), the control section 210 according to the present embodiment can realize vibration presentation that makes the user recall the sense of metal.

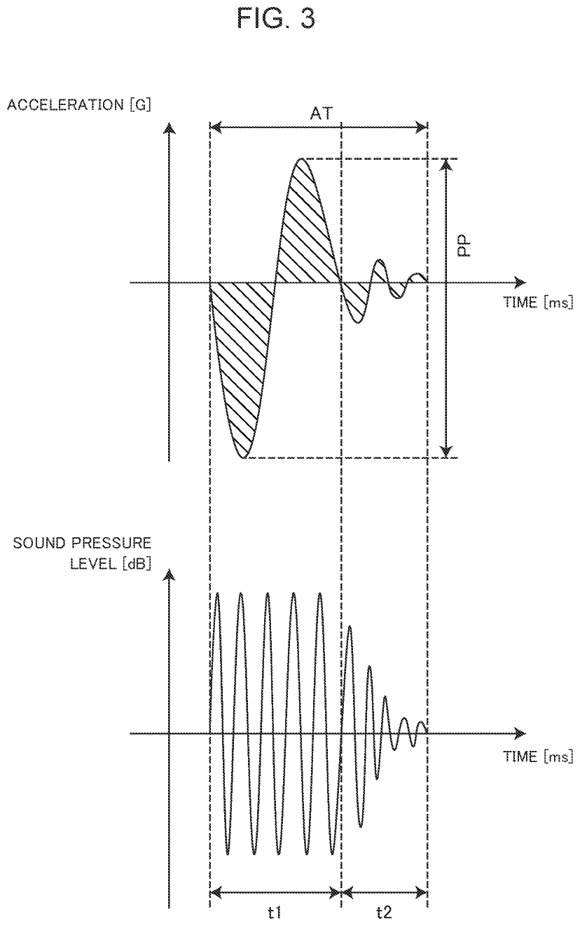

Hereinafter, a control method for making the user recall the sense of metal will be described in more detail with reference to FIG. 3. FIG. 3 is a view for explaining the control method according to the present embodiment. An upper part of FIG. 3 illustrates a time series change (acceleration waveform) of an acceleration that is generated by vibration based on control of the control section 210. A vertical axis indicates an acceleration, and a horizontal axis indicates a time.

In this regard, an intensity of vibration for the input section 110 (the contact area 111 of the input section 110) can be also specified by an area of an acceleration waveform that is determined based on the acceleration peak-to-peak value PP and the acceleration time AT. The above area can be also read as an integrated value of absolute values of the accelerations during the acceleration time AT. FIG. 3 illustrates the above area as a diagonal hatching. When the vibration intensity is specified by the above area, and when the vibration of the specified intensity is output, the control section 210 according to the present embodiment may perform control such that the acceleration peak-to-peak value PP becomes larger and the acceleration time AT becomes shorter while keeping the above area fixed. According to this control, it is possible to produce, for example, heaviness, smallness, highness, and unity, and make the user more strongly recall the sense of metal.

Furthermore, the control section 210 according to the present embodiment may gradually attenuate an acceleration waveform related to vibration according to a specified attenuation rate. The control section 210 may set an attenuation rate such that, for example, an N+1th extremum (a maximum value or a minimal value) of the acceleration waveform is X % of an Nth extremum. According to this control, it is possible to produce a sense of an afterglow that an impact is applied to metal, and make the user more strongly recall the sense of metal by leaving minute residual vibration.

Note that the above attenuation rate may be fixed throughout the acceleration time AT, or may change stepwise. In a case of, for example, an example illustrated in FIG. 3, the control section 210 attenuates an acceleration waveform at a different attenuation rate between a period t1 and a period t2. For example, the control section 210 may set such an attenuation rate that the N+1th extremum is X % of the Nth extremum during the period t1, and set such an attenuation rate that the N+1 th extremum is Y % of the Nth extremum during the period t2.

Furthermore, the control section 210 according to the present embodiment may more strongly produce a sense of metal by presenting the above vibration and controlling auditory presentation. A lower part of FIG. 3 illustrates a time series change (sound waveform) of a sound pressure level of a sound used for auditory presentation based on control of the control section 210. A vertical axis indicates a sound pressure level [dB], and a horizontal axis indicates a time [ms]. Note that the time of the acceleration waveform illustrated in the upper part of FIG. 3 and the time of the sound waveform illustrated in the lower part are synchronized.

In this case, the control section 210 may cause the sound output device 300 to present auditory presentation that uses a sound including a frequency of a high tone range. The above sound may be, for example, a sound including multiple frequencies of approximately 7 kHz to 18 kHz. The above sound including the multiple frequencies can produce a sound generated when an impact is applied to metal, and further enhance the sense of metal that the user recalls.

Furthermore, when the above auditory presentation is performed, the control section 210 according to the present embodiment may gradually attenuate the acceleration waveform related to vibration, and the sound waveform used for the auditory presentation according to a specified attenuation rate. That is, by gradually attenuating the sound, too, similar to vibration, the control section 210 can produce the sense of an afterglow at a time when a tuning fork is hit, and enhance the sense of metal as a result.

Note that, in this case, the attenuation rate of the sound waveform may be the same as or may be different from the attenuation rate of the acceleration waveform. For example, in a case of the example illustrated in FIG. 3, the control section 210 may present a sound of a specified frequency and amplitude in the period t1, and attenuate the sound waveform at the attenuation rate different from the acceleration waveform only in the period t2.

On the other hand, the control section 210 according to the present embodiment performs control such that a timing of an end of attenuation of the acceleration waveform and a timing of an end of attenuation of the sound waveform fall within a range specified as substantially same times. In the case of the example illustrated in FIG. 3, the control section 210 performs control such that the attenuation of the acceleration waveform and the attenuation of the sound waveform end at the substantially same times within the specified range before or after an end of the period t2. According to the above control of the control section 210 according to the present embodiment, it is possible to reduce a sense of strangeness that the user feels from a shift between vibration presentation and auditory presentation by adjusting the timings of the ends of the attenuations of the acceleration waveform and the sound waveform.

<<1.3. Flow of Process>>

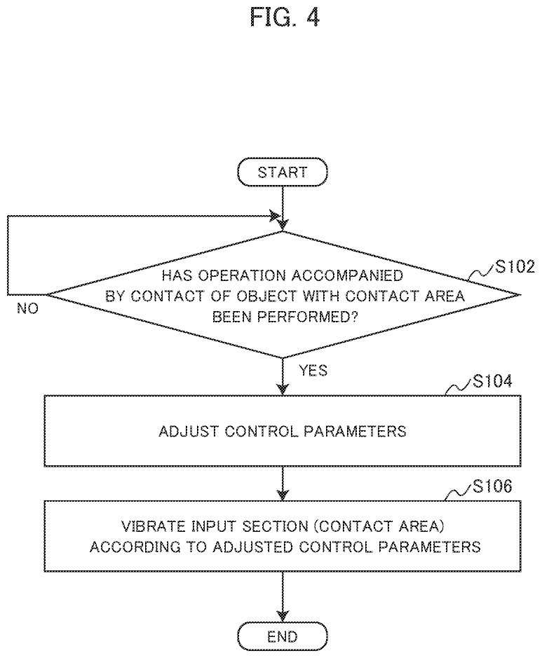

Next, a flow of a feedback process according to the present embodiment will be described in more detail with reference to FIG. 4. FIG. 4 is a view illustrating an example of the flow of the feedback process executed by the system 1 according to the present embodiment.

As illustrated in FIG. 4, the detection section 120 first decides whether or not an operation accompanied by contact of an object with the contact area 111 has been performed (step S102). Note that the above decision in step S102 may be performed based on an electric signal received from the detection section 120. In this regard, when it is decided that the operation is not performed (step S102: NO), the process returns to step S102 again. On the other hand, when it is decided that the operation has been performed (step S102: YES), the process proceeds to step S104 again.

In step S104, the control section 210 adjusts the control parameters. More specifically, the control section 210 adjusts at least the acceleration peak-to-peak value and the acceleration time as the control parameters. Next, the control section 210 vibrates the input section 110 (the contact area 111 of the input section 110) according to the adjusted control parameters (step S106). More specifically, the control section 210 generates a signal for causing the vibration presentation section 130 to output vibration according to the adjusted control parameters, and inputs the generated signal to the vibration presentation section 130. Consequently, the vibration presentation section 130 vibrates according to the adjusted control parameters, and the input section 110 also vibrates according to the adjusted control parameters following the vibration.

The control method according to the present embodiment has been described in detail above. The control method and the control device 200 that realizes the control method according to the present embodiment can provide a mechanism that can realize vibration presentation that makes the user recall a sense of metal.

<2. Supplementary Explanation>

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

For example, the case where the intensity of vibration for the contact area 111 is specified by the area of the acceleration waveform determined based on the acceleration peak-to-peak value and the acceleration time has been described as an example above. However, the vibration intensity according to the present invention is not limited to this example. The vibration intensity may be specified by, for example, an area of a displacement waveform determined based on displacement and a vibration time. The above area can be also referred to as an integrated value of absolute values of displacement during the vibration time. When vibration of the specified intensity is output in this case, the control section 210 may perform control such that displacement becomes greater and the vibration time becomes shorter. Furthermore, the control section 210 may gradually attenuate the displacement waveform related to the vibration according to a specified attenuation rate. Furthermore, when auditory presentation is performed, the control section 210 may perform control such that a timing of an end of the attenuation of the displacement waveform and a timing of an end of attenuation of a sound waveform fall within the range specified as the substantially times.

Furthermore, a series of processes of each device described in this description may be realized by using one of software, hardware, and a combination of the software and the hardware. Programs that configure the software are stored in advance in, for example, recording media (non-transitory media) provided inside or outside each device. Furthermore, each program is read on an RAM when, for example, executed by a computer, and is executed by a processor such as a CPU. The above recording media are, for example, magnetic disks, optical disks, magneto-optical disks, and flash memories. Furthermore, the above computer programs may be distributed via, for example, a network without using the recording media.

### REFERENCE SIGNS LIST

1 system
100 input device
110 input section
111 contact area
120 detection section
130 vibration presentation section
140 support part
200 control device
210 control section
220 storage section
300 sound output device

1. A control device comprising:
a control section configured to vibrate a contact area when it is decided that an input section has been operated by an object, the input section having a contact area that the object contacts,
wherein the control section adjusts as control parameters of control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.

2. The control device according to claim 1, wherein, when an intensity of the vibration for the contact area is specified by an area of an acceleration waveform determined based on the acceleration peak-to-peak value and the acceleration time, and when the vibration of the specified intensity is output, the control section performs control such that the acceleration peak-to-peak value becomes larger and the acceleration time becomes shorter.

3. The control device according to claim 1,
wherein the control section gradually attenuates an acceleration waveform related to the vibration according to a specified attenuation rate.

4. The control device according to claim 1,
wherein the control section outputs auditory presentation that uses a sound including a frequency of a high tone range and is presentation for a sense of hearing.

5. The control device according to claim 4,
wherein the control section gradually attenuates an acceleration waveform related to the vibration and a sound waveform used for the auditory presentation according to a specified attenuation rate.

6. The control device according to claim 5, wherein e control section performs control such that a timing of an end of the attenuation of the acceleration waveform and a timing of an end of the attenuation of the sound waveform fall within a range specified as a substantially same time.

7. A control method comprising:
performing control for vibrating a contact area when it is decided that an input section has been operated by an object, the input section having a contact area that the object contacts,
wherein the performing the control further includes adjusting as control parameters of the control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.

8. A non-transitory computer readable storage medium storing a program, the program causing a computer to realize:
a control function configured to vibrate a contact area when it s decided that an input section has been operated by an object, the input section graving contact area that the object contacts,
wherein the program causes the control function to adjust as control parameters of control for vibrating the contact area an acceleration peak-to-peak value that is a change amount from a first extremum to a second extremum of an acceleration applied by the vibration, and an acceleration time that is a time length from a start time to an end time during which the acceleration applied by the vibration falls within a specified range.
